(19) United States
(12) Patent Application Publication
(10) Pub. No.: US 2024/0417260 A1
(43) Pub. Date: Dec. 19, 2024

(54) OXYGEN-RICH HYPERPOROUS CARBON MATERIAL AND METHOD OF PRODUCING

(71) Applicant: UT-Battelle, LLC, Oak Ridge, TN (US)

(72) Inventors: Tao Wang, Knoxville, TN (US); Sheng Dai, Knoxville, TN (US)

(21) Appl. No.: 18/743,254

(22) Filed: Jun. 14, 2024

Related U.S. Application Data
(60) Provisional application No. 63/521,143, filed on Jun. 15, 2023.

(51) Int. Cl. C01B 32/05

(52) U.S. Cl. CPC C01B 32/05; C01P 2006/12; C01P 2006/16; C01P 2006/40; C01P 2006/80

(57) ABSTRACT

A porous carbon material having a Brunauer-Emmett-Teller (BET) surface area of at least 2600 m²/g, an oxygen content of at least 1 wt %, a nitrogen content of at least 0.1 wt %, and wherein at least 80 vol % of pores in the porous carbon material have a pore size of no more than 10 nm. Also described are methods for producing a porous carbon material, wherein the method includes mixing a hypercrosslinked polymer with a metal amide or metal nitride to form a mixture, and heating the mixture to a temperature within a range of 350-1000° C. for a time period of at least 1 hour to result in conversion of the hypercrosslinked polymer to the porous carbon material. Further described herein are capacitors, supercapacitors, and batteries containing the porous carbon material incorporated therein, typically in the form of a porous carbon membrane.

### CROSS-REFERENCE TO RELATED APPLICATIONS

This application claims priority from U.S. Provisional Application No. 63/521,143, filed Jun. 15, 2023, which is herein incorporated by reference in its entirety.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to the field of porous carbon materials, and more particularly, porous carbon materials containing an oxygen content and a high surface area of at least 3000 m²/g, as well as methods of producing such carbon materials by using porous polymers as carbonization precursor materials.

### BACKGROUND OF THE INVENTION

Supercapacitors are critical energy storage devices for applications that require high power density and long cycle lifetime, such as regenerative braking systems in electric vehicles, uninterruptible power supplies, and power levelers for electronics. With the fast development of supercapacitors, diverse materials, such as porous carbons, metal oxides/carbides/nitrides, and conductive polymers, have been optimized to pursue a higher energy density in supercapacitors, among which porous carbons have been the primary and widely used active materials for commercial supercapacitors. The advantages of porous carbons for supercapacitors include power capability, long-term cycle stability, wide operating temperatures, and high Coulombic efficiencies.

The basic energy storage mechanism of carbon supercapacitors is through an electrical double-layer capacitance (EDLC), derived from the reversible charge separation at the interface of the electrolyte with the carbon surface. The large surface area and appropriate pore structure of carbon supercapacitors are crucial to providing a large interfacial area for a large EDLC as well as a fast ionic mobility path for high charge/discharge rates. In addition, a heteroatom-doped carbon surface with electro-active species, such as N/O sites and metal/metal oxide particles, provides pseudo-capacitance through quick and reversible faradic reactions, which contributes to a high overall capacitance value. The theoretical upper limit of the specific surface area for carbonaceous materials has been calculated as 2630 m²/g, which was calculated from an infinite single graphite layer (K. Kaneko et al., Carbon 30, 1075-1088, 1992). Highly porous carbons with surface areas larger than 2630 m²/g are promising for high-energy supercapacitors but still largely inaccessible using currently available synthetic strategies.

The carbonization-activation strategy is a known method for accessing highly porous carbons by oxidation of carbonous precursors with physical activation agents (CO₂, O₂, air, or H₂O) or chemical activation agents (KOH, Na₂CO₃, ZnCl₂, or H₃PO₄) at high temperature. However, the achievement of a hyperporous carbon with an ultra-high surface area of 3000 m²/g or 4000 m²/g or above remains elusive using current methods. Moreover, the high activation temperature above 800° C. used in conventional strategies generally results in a significant loss of functional groups and a low carbon yield. Thus, a method for producing highly porous carbon with a substantial oxygen content and high surface area of at least 3000 m²/g or 4000 m²/g would be a significant advance in the field of porous carbon materials. The method would be further advantageous if it was capable of producing such unique carbon materials by straight-forward means and with the use of lower temperatures than commonly practiced in the art.

### SUMMARY

In one aspect, the present disclosure is directed to porous carbon materials having a Brunauer-Emmett-Teller (BET) surface area of at least or above 2600 m²/g or 3000 m²/g, an oxygen content of at least 1 wt %, and a nitrogen content of at least 0.1 wt %. Typically, at least 80 vol % of pores in the porous carbon material have a pore size of no more than 10 nm. In some embodiments, the porous carbon material has a surface area of at least or above 3500 m²/g or 4000 m²/g. In separate or further embodiments, the porous carbon material may have an oxygen content of at least or above 5 wt %, 10 wt %, or 15 wt %. In separate or further embodiments, the porous carbon material may have a nitrogen content of at least or above 0.5 wt %, 1 wt %, or 1.5 wt %. In separate or further embodiments, the porous carbon material may have at least 90 vol % of its pores within a pore size of no more than 10 nm. In separate or further embodiments, the porous carbon material may have at least 60 vol % of its pores within a pore size of 0.1-5 nm. By virtue of the highly porous structure and high oxygen doping content, these hyperporous carbons may exhibit a high specific capacitance as high as 610 F/g (or higher) in an acid electrolyte, which approaches the predicted capacitance up-limit of porous carbon supercapacitors

In another aspect, the present disclosure is directed to a novel method for producing the above-described porous carbon material. The method involves mixing a hypercrosslinked polymer with an activating agent (e.g., metal amide or metal nitride) to form a mixture, and heating the mixture to a temperature within a range of 350-1000° C. for a time period of at least 1 hour to result in conversion of the hypercrosslinked polymer to the porous carbon material. The method is advantageously straight-forward, capable of employing substantially lower temperatures than commonly practiced in the art, and capable of producing carbon materials containing exceptionally high surface areas of at least or above 2600 m²/g, 3000 m²/g, 3500 m²/g, or 4000 m²/g. The method is advantageously also capable of selectively tailoring the porosity, surface area, oxygen, and nitrogen content by appropriate selection of, for example, temperature, processing time, hypercrosslinked polymer, and choice of activating agent. In particular embodiments, the method includes two heating steps in which a first heating step subjects the mixture to a temperature in a range of 350-450° C. for at least one hour and the first heating step is followed by a second heating step which subjects the mixture to a temperature in a range of 500-1000° C. for at least one hour.

In yet another aspect, the present disclosure is directed to supercapacitors (ultracapacitors) containing the above described porous carbon material. The porous carbon material typically functions as one or more electrodes in the supercapacitor. The supercapacitor typically also includes an ion-permeable membrane that functions to separate the electrodes. The supercapacitor typically also includes an electrolyte containing positive and negative ions, as well as a power source and collector.

### BRIEF DESCRIPTION OF THE DRAWINGS

FIG. 1. Schematic illustration of an exemplary synthesis of hyperporous carbon materials studied herein.

FIGS. 2a-2f. Characterization of hypercrosslinked polymer based on phloroglucinol (HCP-Phl) and carbonized forms thereof by carbonization at 600 and 700° C. (i.e., C-Phl-600 and C-Phl-700, respectively). FIG. 2a shows the structure of HCP-Phl along with its ¹³C CP/MAS NMR spectrum. FIG. 2b is a graph showing N₂ adsorption-desorption isotherms of C-Phl-600 and C-Phl-700 at 77 K. FIG. 2c is a graph showing NLDFT pore distributions of C-Phl-600 and C-Phl-700. FIG. 2d is a STEM image of C-Phl-600. FIG. 2e is a graph showing O and N contents in C-Phl-500, C-Phl-600, and C-Phl-700 calculated from element analysis. FIG. 2f shows XPS spectra of C-Phl-600 and C-Phl-700. Note: “C-Phl” in the figures indicates “C-Phl-600”.

FIGS. 3a-3f. Electrochemical performance of C-Phl-600 and C-Phl-700 in 1 M H₂SO₄. FIG. 3a shows CV curves of C-Phl-600 at different scan rates from 1 to 500 mV/s. FIG. 3b shows CV curves of C-Phl-600 and C-Phl-700 at 50 mV/s. FIG. 3c shows specific capacitances of C-Phl-600 and C-Phl-700 at different scan rates calculated from CV curves. FIG. 3d is a graph showing GCD curves of C-Phl-600 at different specific currents from 0.2 to 100 A/g. FIG. 3e shows a discharge curve of C-Phl-600 at 0.2 A/g. FIG. 3f is a graph showing specific capacitances of C-Phl-600 at different specific currents calculated from Equations 1 and 2.

FIGS. 4a-4d. Hyperporous carbons from different HCPs. FIG. 4a shows N₂ adsorption-desorption isotherms of hyperporous carbons (C-Phl, C-Res, C-Phe, and C-Ben) and a hypercrosslinked polymer (HCP-Ben) at 77 K. FIG. 4b is a graph plotting NLDFT pore distributions of hyperporous carbons and HCP-Ben. FIG. 4c is a bar graph showing BET surface areas with contributions from micropores and mesopores for hyperporous carbons and HCP-Ben. FIG. 4d is a graph plotting specific capacitances of hyperporous carbons at different scan rates calculated from CV curves.

### DETAILED DESCRIPTION

In a first aspect, the present disclosure is directed to a porous carbon material (also referred to herein as a “hyperporous carbon material”) having a Brunauer-Emmett-Teller (BET) surface area of at least or above 2600 m²/g, an oxygen content of at least or above 1 wt %, and a nitrogen content of at least or above 0.1 wt %. In different embodiments, the porous carbon material may have a surface area of at least or above 2600 m²/g, 2630 m²/g, 2650 m²/g, 2700 m²/g, 2800 m²/g, 2900 m²/g, 3000 m²/g, 3200 m²/g, 3500 m²/g, 3800 m²/g, 4000 m²/g, 4200 m²/g, 4500 m²/g, 4800 m²/g, 5000 m²/g, or 5500 m²/g, or a surface area within a range bounded by any two of the foregoing values (e.g., 2600-5500 m²/g, 2630-5500 m²/g, 2650-5500 m²/g, 2700-5500 m²/g, 2800-5500 m²/g, 2900-5500 m²/g, 3000-5500 m²/g, 3500-5500 m²/g, 4000-5500 m²/g, or 4500-5500 m²/g). In separate or further embodiments, the porous carbon material may have an oxygen content of at least or above 1 wt %, 2 wt %, 5 wt %, 10 wt %, 15 wt %, or 20 wt %, or an oxygen content within a range bounded by any two of the foregoing values (e.g., 1-20 wt % or 5-20 wt %). In separate or further embodiments, the porous carbon material may have a nitrogen content of at least or above 0.1 wt %, 0.2 wt %, 0.5 wt %, 0.8 wt %, 1 wt %, 1.2 wt %, 1.5 wt %, 1.8 wt %, or 2 wt %, or a nitrogen content within a range bounded by any two of the foregoing values (e.g., 0.1-2 wt %, 0.2-2 wt %, 0.5-2 wt %, 0.8-2 wt %, 0.1-1.8 wt %, 0.2-1.8 wt %, 0.5-1.8 wt %, or 0.8-1.8 wt %). Notably, any of the foregoing values or ranges for the surface area, oxygen content, and nitrogen content may be independently selected and combined to arrive at a porous carbon material useful for the present invention. In separate or further embodiments, the porous carbon material may exhibit a high specific capacitance of at least or above 500, 550, 600, 610, 620, or 650 F/g in an acid electrolyte.

At least 80, 90, 95, 98, 99, or 100 vol % of pores in the porous carbon material have a pore size of no more than 10 nm. Pores having a pore size greater than 10 nm, if present, may have a pore size of up to, for example, 20 nm, 50 nm, 100 nm, 200 nm, 500 nm, 1000 nm, or 2000 nm. For example, in various embodiments, about 80, 85, 90, or 95 vol % of a first portion of pores may have a pore size of up to or less than 10 nm, 8 nm, or 5 nm, while about 20, 15, 10, or 5 vol % of a second portion of pores may have a size greater than 10 nm, 8 nm, or 5 nm, respectively, and a size up to, for example, 20 nm, 50 nm, 100 nm, 200 nm, 500 nm, 1000 nm, or 2000 nm, wherein the total vol % of the first and second portions of pores sum to 100 vol %. In some embodiments, at least 80, 90, 95, 98, 99, or 100 vol % of pores in the porous carbon material have a pore size of no more than 8 nm, 5 nm, 3 nm, or 2 nm, provided that at least 80, 90, 95, 98, 99, or 100 vol % of pores in the porous carbon material have a pore size of no more than 10 nm. In other embodiments, at least 50, 60, 70, 80, or 90 vol % of pores in the porous carbon material have a pore size within a range of 0.1-5 nm, 0.2-5 nm, 0.5-5 nm, or 1-5 nm, wherein the foregoing ranges can be considered attributed to a first portion of pores, which can be in combination with a second portion of pores having a size greater than 5 nm and a size up to, for example, 10 nm, 15 nm, 20 nm, 50 nm, 100 nm, 200 nm, 500 nm, 1000 nm, or 2000 nm (or a range of sizes bounded by any two of the foregoing values), wherein the total vol % of the first and second portions of pores sum to 100 vol %. Notably, any of the foregoing values or ranges of the pore size provided above may be combined with any of the values or ranges for the surface area, oxygen content, and nitrogen content, as provided earlier above, to arrive at a porous carbon material useful for the present invention.

In some embodiments, the porous carbon material possesses micropores, which correspond to pore sizes less than 2 nm. In different embodiments, the micropores have a size of precisely, about, up to, or less than, for example, 0.1, 0.2, 0.3, 0.4, 0.5, 0.6, 0.7, 0.8, 0.9, 1.0, 1.2, 1.5, or 1.8 nm, or a particular pore size, or a distribution of pore sizes, within a range bounded by any two of these values (e.g., 0.1-2 nm, 0.2-2 nm, or 0.5-2 nm). As used herein, the term “about” generally indicates within ±0.5%, 1%, 2%, 5%, or up to ±10% of the indicated value. For example, a pore size of about 10 nm generally indicates in its broadest sense 10 nm±10%, which indicates 9.0-11.0 nm.

In some embodiments, the porous carbon material possesses mesopores, which correspond to pore sizes of at least or above 2 nm and up to or less than 50 nm. In different embodiments, the mesopores have a pore size of precisely, about, at least, above, up to, or less than, for example, 3 nm, 4 nm, 5 nm, 6 nm, 7 nm, 8 nm, 9 nm, 10 nm, 11 nm, 12 nm, 15 nm, 20 nm, 25 nm, 30 nm, 35 nm, 40 nm, or 45 nm, or a particular pore size, or a distribution of pore sizes, within a range bounded by any two of the foregoing exemplary values, or between 2 nm and any of the foregoing exemplary values, or between one of the foregoing exemplary pore sizes and 50 nm.

In some embodiments, the porous carbon material possesses macropores, which correspond to pore sizes greater than 50 nm. In different embodiments, the macropores have a size of precisely, about, at least, or greater than, for example, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 250 nm, 300 nm, 350 nm, 400 nm, 450 nm, 500 nm, 600 nm, 700 nm, 800 nm, 900 nm, 1000 nm (1 μm), 1.5 μm, 2 μm, 3 μm, 4 μm, or 5 μm, or a particular pore size, or a distribution of pore sizes, within a range bounded by any two of the foregoing values.

In a first set of embodiments, the porous carbon material possesses only micropores, without mesopores or macropores. In a second set of embodiments, the porous carbon material possesses only micropores and mesopores (i.e., without macropores). In a third set of embodiments, the porous carbon material possesses micropores, mesopores, and macropores. In a fourth set of embodiments, the porous carbon material possesses only mesopores. In a fifth set of embodiments, the porous carbon material possesses only mesopores and macropores (i.e., without micropores).

The pores are generally circular or oval-shaped. For circular or substantially circular pores, the pore size refers to the diameter of the pore. For pores that are substantially unsymmetrical or irregularly shaped, the pore size generally refers to either the average of the pore dimensions for a particular pore, or to the average or longest dimension of such pores averaged over a population of such pores.

In one set of embodiments, a single distribution of pores is present in the porous carbon material. A distribution (or “mode”) of pores is generally defined by a single pore size of maximum (peak) pore volume concentration. The peak pore volume may be in the micropore, mesopore, or macropore size range.

In some embodiments, the porous carbon material possesses a bimodal, trimodal, or higher modal pore size distribution, which can be identified by the presence of, respectively, two, three, or a higher number of peak pore volume concentrations. In the case of a bimodal pore size distribution, the pore size distribution may be defined by a minimum pore size in the micropore size range and a maximum pore size in the mesopore or macropore size range, with one peak pore volume in the micropore size range and one peak pore volume in the mesopore or macropore size range, or alternatively, with both peak pore volumes in the micropore size range, mesopore size range, or macropore size range. A bimodal pore size distribution may alternatively be characterized by a minimum pore size in the mesopore size range and a maximum pore size in the macropore size range, with one peak pore volume in the mesopore size range and one peak pore volume in the macropore size range. A trimodal pore size distribution may be characterized by, for example, one peak pore volume in the micropore size range, one peak pore volume in the mesopore size range, and one peak pore volume in the macropore size range, or alternatively, one peak pore volume in the micropore size range and two peak pore volumes in the mesopore size range or macropore size range, or two peak pore volumes in the mesopore size range and a peak pore volume in the macropore size range.

The pores of the porous carbon material can also possess a level of uniformity, generally either in pore diameter, pore shape, and/or pore interspacing. In particular embodiments, the pores of the porous carbon material may possess an average pore size corresponding to any of the pore sizes exemplified above, subject to a degree of variation of no more than, for example, ±10 nm, ±8 nm, ±6, nm, ±5 nm, ±4 nm, ±3 nm, ±2 nm, ±1 nm, or ±0.5 nm. In some embodiments, any one of the types of pores described above (e.g., the micropores or mesopores) are substantially uniform in size. The pores may also be arranged relative to each other with a certain degree of order, i.e., in a patterned or ordered arrangement. Some examples of ordered arrangements include a hexagonal or cubic arrangement.

The porous carbon material may also possess a total pore volume of precisely, about, or at least, for example, 0.2 cm³/g, 0.3 cm³/g, 0.4 cm³/g, 0.5 cm³/g, 0.6 cm³/g, 0.7 cm³/g, 0.8 cm³/g, 0.9 cm³/g, 1.0 cm³/g, 1.2 cm³/g, 1.5 cm³/g, 1.8 cm³/g, 2 cm³/g, 2.2 cm³/g, 2.5 cm³/g, 3.0 cm³/g, 3.5 cm³/g, 4.0 cm³/g, 4.5 cm³/g, 5.0 cm³/g, 5.5 cm³/g, or 6.0 cm³/g, or a pore volume within a range bounded by any two of these values.

In some embodiments, the porous carbon material is in the form of a membrane (i.e., film), such as for use as an electrode in a supercapacitor. The thickness of the porous carbon membrane is typically at least or above 20 microns (20 μm), but can be lower than 20 μm in some embodiments. In different embodiments, the porous carbon membrane may have a thickness of precisely, about, up to, less than, at least, or above, for example, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 110 μm, 120 μm, 130 μm, 140 μm, 150 μm, 200 μm, 220 μm, 250 μm, 300 μm, 320 μm, 350 μm, 400 μm, 450 μm, 500 μm, 600 μm, 700 μm, 800 μm, 900 μm, or 1000 μm, or a thickness within a range bounded by any two of these values.

The porous carbon membrane may or may not also function as part of a layered composite material, wherein the porous membrane either overlays, underlies, or is sandwiched between one or more layers of another material. In some embodiments, the one or more layers of another material provides greater structural integrity to the membrane. In some embodiments, the one or more layers of another material provides a function suited for a capacitor, supercapacitor, or battery. The one or more layers of another material may function, for example, as a solid electrolyte or metal collector (e.g., Al). The one or more layers of another material may be porous or non-porous, and can be composed of, for example, a ceramic (e.g., silica, alumina, or aluminosilicate), metal oxide, or an organic, inorganic, or hybrid polymer, or combination thereof, depending on the particular application. In some embodiments, the porous carbon membrane is monolithic (i.e., not disposed on or overlaid with a substrate).

In another aspect, the present disclosure is directed to a method for producing the porous carbon material described above. In the method, a hypercrosslinked polymer is mixed with a metal amide or a metal nitride to form a mixture, and the mixture is heated to a temperature within a range of 350-1000° C. for a time period of at least 1 hour to result in conversion of the hypercrosslinked polymer to the porous carbon material described above having any of the surfaces, oxygen contents, nitrogen contents, and pore size ranges or distributions described above. The metal amide is typically an alkali amide, such as LiNH₂, NaNH₂, or KNH₂. The metal amide may, in some embodiments, be an alkaline earth amide, such as Mg(NH₂)₂. The metal nitride is typically an alkali metal nitride, such as Li₃N, Na₃N, or K₃N.

The phrase “for at least 1 hour” is herein understood to mean that the mixture is subjected to one or more temperatures within a range of 350-1000° C. for a period of at least one hour to result in conversion of the hypercrosslinked polymer to the porous carbon material. The phrase “for at least 1 hour” also includes the possibility of “about one hour” or at least or about two hours, three hours, or four hours, or a period of time within a range therein, e.g., 1-4 hours. In different embodiments, the mixture is heated to a temperature of precisely or about, for example, 350° C., 400° C., 450° C., 500° C., 550° C., 600° C., 650° C., 700° C., 750° C., 800° C., 850° C., 900° C., 950° C., or 1000° C. for a period of at least one hour. In some embodiments, the mixture is heated to a temperature within a range bounded by any two of the foregoing values, e.g., 350-900° C., 350-800° C., 350-700° C., 350-600° C., 350-500° C., 400-900° C., 400-800° C., 400-700° C., 400-600° C., 400-500° C., 450-900° C., 450-800° C., 450-700° C., 450-600° C., 450-500° C., 500-900° C., 500-800° C., 500-700° C., or 500-600° C. for a period of at least one hour.

The phrase “heated to a temperature” may, in one instance, mean that the mixture is subjected to a single temperature within a range of 350-1000° C. or sub-range therein for a period of at least one hour. The term “heated to a temperature” may, in a second instance, include the possibility of the mixture being heated to at least one lower temperature followed by at least one higher temperature within a range of 350-1000° C. or a sub-range therein, wherein the mixture is subjected to the lower and higher temperatures for a total period of at least one hour (such as, e.g., at least 0.5 hour at the lower temperature and at least 0.5 hour at the higher temperature). In further embodiments, the mixture may be subjected to a range of temperatures spanning an initial temperature to a final temperature within a range of 350-1000° C. or sub-range thereof for a period of at least one hour. The mixture may be subjected to the range of temperatures by being increased in temperature by a specified temperature ramp rate, such as a ramp rate of 1, 2, 5, or 10° C./min. In some embodiments, the mixture may be ramped in temperature starting from an initial temperature below the specified temperature range (e.g., room temperature, typically about 25° C.) and up to a final temperature within any of the ranges provided above, wherein the period of time that the mixture resides at a temperature below the specified temperature range does not count toward the at least 1 hour of time.

Moreover, the mixture may be heated for a period of time of at least or about 1, 2, 3, or 4 hours at a first (lower) temperature followed by a period of time of at least or about 1, 2, 3, or 4 hours at a second (higher) temperature. For example, the heating step may include precisely or at least two heating steps in which a first heating step subjects the mixture to a temperature within a range of 350-450° C. (or precisely or about 350° C. or) for at least or about 1, 2, 3, or 4 hours and the first heating step is followed by a second heating step which subjects the mixture to a temperature of about 500° C., 550° C., 600° C., 650° C., 700° C., 750° C., 800° C., 850° C., 900° C., 950° C., or 1000° C. or a temperature within a range of 500-1000° C., 500-900° C., 500-800° C., or 500-700° C. for at least or about 1, 2, 3, or 4 hours.

Hypercrosslinked polymers are well known in the art. The hypercrosslinked polymer used herein as a precursor for producing the porous carbon material can be any of the hypercrosslinked polymers known in the art, such as described in, for example, L. Tan et al., Chem. Soc. Rev., 46, 3322, 2017, which is herein incorporated by reference. The hypercrosslinked polymers are generally nanoporous or microporous and often contain aromatic rings, wherein the aromatic rings may be carbocyclic or heteroaromatic rings. In many instances, the hypercrosslinked polymers contain aromatic rings crosslinked by methylene groups. The hypercrosslinked polymer may be, for example, a crosslinked polystyrene or copolymer thereof (e.g., polystyrene-co-divinylbenzene). In other embodiments, the hypercrosslinked polymer may be a crosslinked poly(vinylbenzylchloride) (i.e., poly(VBC)), crosslinked poly(arylsulfone), crosslinked polyphenyl ether, crosslinked polyarylate, crosslinked polyaniline, crosslinked polypyrrole, crosslinked polyphenylene sulfide, and crosslinked polysilsesquioxane-containing polymers. In other embodiments, the hypercrosslinked polymer may be a result of crosslinking benzene, phenol, resorcinol, or phloroglucinol molecules.

The hypercrosslinked polymer is typically produced by reaction of an aromatic monomer or polymer with a crosslinker in the presence of a Lewis acid, as done in Friedel-Crafts reactions. The crosslinker should have the capacity to crosslink between aromatic groups or between aromatic groups and another part of the polymer. The aromatic ring in the precursor polymer may or may not also be substituted with one or more groups, as long as at least one position remains on the aromatic ring for Friedel-Crafts alkylation, and as long as the substituting group does not substantially deactivate the aromatic ring. The Friedel-Crafts reaction can employ any of the conditions and reagents well known in the art for conducting such a reaction. The Friedel-Craft catalysts may be any of those well known in the art, e.g., ferric chloride (FeCl₃), aluminum trichloride (AlCl₃), GaCl₃, SbCl₅, BF₃, or BiCl₃. The solvent may also be any of the organic solvents known in the art, as long as the solvent does not degrade, react with, dissolve, or otherwise adversely affect the polymer hypercrosslinked polymer. The solvent may be, for example, a halogenated organic solvent, such as methylene chloride (DCM) or 1,2-dichloroethane (DCE).

The crosslinker can be any molecule that possesses at least two reactive groups that can engage in crosslinking between monomers or between parts of a polymer to form a crosslinked polymer. More typically, the crosslinker is a molecule that possesses at least two reactive groups that engage in a Friedel-Crafts reaction with aromatic rings. In specific embodiments, the crosslinker is dimethoxymethane (FDA) or formaldehyde, both of which result in methylene linkages. The reactive groups may be selected from, for example, ether groups (e.g., methoxy or ethoxy groups), alkyl chlorides, alkyl bromides, acyl chlorides, and acyl bromides. Some examples of crosslinking molecules include:

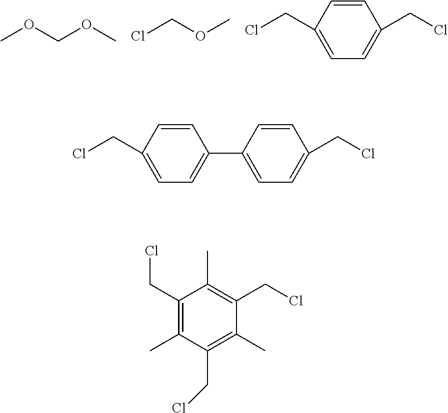

In some embodiments, the crosslinker is an aldehyde, acetal, or ketal. Any of the foregoing types of crosslinkers may be reacted with any of the types of monomers or polymers described above under Friedel-Crafts conditions to form a hypercrosslinked polymer. In particular embodiments, the hypercrosslinked polymer is produced by crosslinking of benzene, phenol, resorcinol, or phloroglucinol with an aldehyde, acetal, or ketal under Friedel-Crafts conditions.

In some embodiments, the crosslinker is an aldehyde. The aldehyde crosslinker can be any organic compound or material containing an aldehyde group. In some embodiments, the crosslinkable aldehyde is formaldehyde. However, there are numerous organoaldehydes, organodialdehydes, and polyaldehydes (e.g., organotrialdehydes, organotetraaldehydes, and so on) considered herein which can serve the same purpose. The organoaldehydes can be generally represented by the following formula:

R—CHO (1)

In Formula (1), R can represent a straight-chained, branched, or cyclic hydrocarbyl group, which can be either saturated or unsaturated, typically containing at least 1, 2, or 3 carbon atoms, and up to 4, 5, 6, 7, or 8 carbon atoms. Some examples of suitable organoaldehydes include acetaldehyde, propanal (propionaldehyde), butanal (butyraldehyde), pentanal (valeraldehyde), hexanal, crotonaldehyde, acrolein, benzaldehyde, and furfural.

The organodialdehydes can be generally represented by the following formula:

OHC—R—CHO (2)
wherein R is a bond (in the case of glyoxal) or a straight-chained, branched, or cyclic hydrocarbyl linking group, which can be either saturated or unsaturated, typically containing at least 1, 2, or 3 carbon atoms, and up to 4, 5, 6, 7, 8, 9, or 10 carbon atoms. Some examples of dialdehyde compounds include glyoxal (when R is a bond), malondialdehyde (when R is methylene), succinaldehyde, glutaraldehyde, adipaldehyde, pimelaldehyde, suberaldehyde, sebacaldehyde, cyclopentanedialdehyde, terephthaldehyde, and furfuraldehyde. In some embodiments, one of the aldehydic hydrogens of a dialdehyde can be replaced with a hydrocarbyl group, thereby resulting in an aldehyde-ketone dione compound, such as methylglyoxal or 1,3-butanedione.

Typically, after the hypercrosslinked polymer is produced, the polymer is washed by rinsing. The rinsing process can employ a suitable solvent (e.g., acetone, hydrocarbon solvent, ether, and/or water) and may or may not include an acid, such as hydrochloric acid. The washed polymer is then typically dried at a suitable temperature, such as at any of the temperatures provided above, but typically up to or less than 100° C., 80° C., or 60° C.

The hypercrosslinked polymer may possess any of the pore sizes or pore size distributions (including monomodal, bimodal, or trimodal distributions) provided earlier above for the hyperporous carbon material. The hypercrosslinked polymer may possess, for example, any of the micropores, mesopores, and/or macropores described above for the hyperporous carbon material. The pores in the hypercrosslinked polymer may also possess any of the total pore volumes provided above, levels of uniformity provided above, and may or may not be in the form of a membrane, as described above.

In yet another aspect, the instant disclosure is directed to a device in which the porous carbon material is incorporated. In particular embodiments, the porous carbon material is incorporated (typically in the form of a membrane) into a capacitor or supercapacitor. The porous carbon material may have other applications, such as a component (e.g., membrane) of a battery (e.g., lithium-ion battery) or fuel cell, catalyst support, or component of an energy storage or conversion device. In the case of a supercapacitor, the porous carbon material typically functions as one or more electrodes in the supercapacitor. The supercapacitor typically also includes an ion-permeable membrane that functions to separate the electrodes. The supercapacitor typically also includes an electrolyte containing positive and negative ions, as well as a power source and collector. As well known, the electrodes become polarized and oppositely charged upon application of the power source. The electrodes may also be symmetric or asymmetric, as well known in the art.

Examples have been set forth below for the purpose of illustration and to describe certain specific embodiments of the invention. However, the scope of this invention is not to be in any way limited by the examples set forth herein.

### EXAMPLES

### Overview

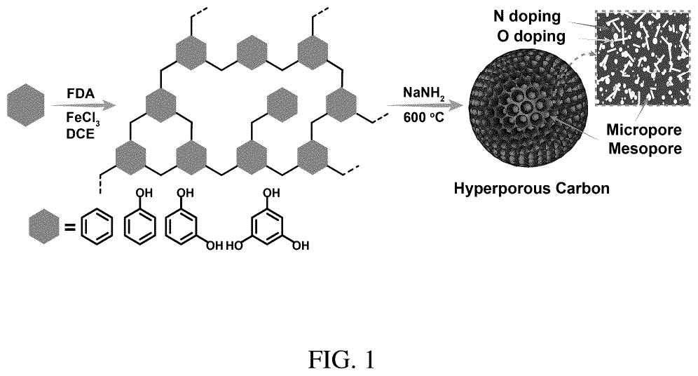

Hypercrosslinked polymers (HCPs) as the precursors for hyperporous carbons were synthesized by crosslinking benzene or phenols (phenol, resorcinol, or phloroglucinol) with dimethoxymethane (FDA) through a simple one-step Friedel-Crafts reaction (FIG. 1). Hyperporous carbons were obtained by carbonization of HCPs under 600° C. using NaNH₂ as an activation agent, in which the low carbonization/activation temperature was used to retain a high heteroatom doping content in products. Hyperporous carbons using different HCP precursors were named after their corresponding monomers. The Brunauer-Emmett-Teller (BET) surface area of hyperporous carbons was herein found to increase with the number of phenolic hydroxyl groups, from 2903 m²/g of benzene-based hyperporous carbon (C-Ben) to 4476 m²/g of phloroglucinol-based hyperporous carbon (C-Phl).

A data-driven machine learning model based on the artificial neural network (ANN) was used for predicting the properties (e.g., capacitance) of a series of hyperporous N/O co-doped carbon materials. From the calculations, the capacitance up-limit of N/O co-doped carbons was herein predicted to increase from 570 to 611 F/g. The ANN predicted maximum value for N/O-doped carbons in 1 M H₂SO₄ occurs at the specific surface areas from micropores and mesopores at 1502 and 687 m²/g, respectively, together with the O content of 20 atom % and the N content of 0.5 atom %. In agreement with the ANN prediction, the specific capacitance of C-Phl was herein found to be as high as 610 F/g at a scan rate of 1 mV/s and 628 F/g at a current density of 0.2 A/g in 1 M H₂SO₄ solution. Guided by the ANN machine learning results, these hyperporous carbons with ultra-high surface area, unique micropore-mesopore structure, and abundant N/O doping can approach the capacitance boundary of carbon capacitors.

### Preparation of Hypercrosslinked Polymers (HCPs)

Preparation of HCP by Crosslinking of Benzene (HCP-Ben). 9.75 g of anhydrous ferric chloride was added to a solution of benzene (1.56 g) and dimethoxymethane (FDA) (4.56 g) in 20 mL of 1,2-dichloroethane under stirring. The mixture was heated to 45° C. for 5 h and then to 80° C. for 19 h. The product was collected and washed with methanol by vacuum filtration and then washed with refluxed methanol in a Soxhlet extractor for 24 h. Then the product was dried at 60° C. in a vacuum oven.

Preparation of HCP by Crosslinking of Phenol (HCP-Phe). 6.50 g of anhydrous ferric chloride was added to a solution of phenol (1.98 g) and FDA (3.04 g) in 20 mL of 1,2-dichloroethane under stirring. The mixture was heated to 45° C. for 5 h and then to 80° C. for 19 h. The product was collected and washed with methanol by vacuum filtration and then washed with refluxed methanol in a Soxhlet extractor for 24 h. Then the product was dried at 60° C. in a vacuum oven.

Preparation of HCP by Crosslinking of Resorcinol (HCP-Res). 6.50 g of anhydrous ferric chloride was added to a solution of resorcinol (2.00 g) and FDA (3.04 g) in 20 mL of 1,2-dichloroethane under stirring. The mixture was heated to 45° C. for 5 h and then to 80° C. for 19 h. The product was collected and washed with methanol by vacuum filtration and then washed with refluxed methanol in a Soxhlet extractor for 24 h. Then the product was dried at 60° C. in a vacuum oven.

Preparation of HCP by Crosslinking of Phloroglucinol (HCP-Phl). 6.50 g of anhydrous ferric chloride was added to a solution of phloroglucinol (2.00 g) and FDA (3.04 g) in 20 mL of 1,2-dichloroethane under stirring. The mixture was heated to 45° C. for 5 h and then to 80° C. for 19 h. The product was collected and washed with methanol by vacuum filtration and then washed with refluxed methanol in a Soxhlet extractor for 24 h. Then the product was dried at 60° C. in a vacuum oven.

### Preparation of Hyperporous Carbons

Taking the synthesis of C-Phl-600 (i.e., “C-Phl”) as an example, 0.50 g of HCP was mixed with 1.00 g of NaNH₂ by hand grinding in an argon glove box. Note, NaNH₂ is reactive to water or oxygen, and for this reason, NaNH₂ and hypercrosslinked polymer were mixed in an argon-filled glove box before activation. The mixture was heated to 350° C. for 1 hour with a heating rate of 5° C./min and then to 600° C. for 2 hours with a heating rate of 5° C./min in a tube furnace. After cooling to room temperature, the carbon product was washed with water and collected by vacuum filtration. Then the product was soaked in 3 M HCl solution, heated to 60° C. for 5 hours, and washed with water again by vacuum filtration. Finally, the product was dried at 100° C. in a vacuum oven to obtain the C-Phl. Other hyperporous carbons were synthesized using their corresponding HCPs under the same condition. C-Phl-700 and C-Phl-500 were synthesized by changing the heating temperature from 600° C. to 700 and 500° C., respectively. The other treatments were conducted in the same manner as C-Phl.

### Electrode Preparation and Electrochemical Protocol

14 mg of hyperporous carbon, 4 mg of carbon black (acetylene black), 40 μl of Nafion solution (5 wt %), and 0.96 ml of isopropanol were mixed to obtain an ink. 10 μl of the ink was drop cast onto a polished glassy carbon rod as the working electrode. The diameter of the glassy carbon rod was 5 mm, which provided an electrode area of 0.2 cm². The mass loading of hyperporous carbon on the working electrode was about 0.7 mg cm-2. For a high loading of 4.2 mg cm-2, 60 μl of the ink was drop-cast onto a polished glassy carbon rod as the working electrode. The thickness of the electrodes (without current collectors) at a low mass loading of 0.7 mg/cm² is 30 μm. For a high mass loading of 4.2 mg/cm², the thickness is 157 μm. Hg/Hg₂SO₄ electrode (0.64 V vs. NHE) filled with a concentrated K₂SO₄ supporting solution was used as the reference electrode, 1 M H₂SO₄ aqueous solution as an electrolyte, and a piece of platinum mesh as the counter electrode. The electrochemical data were collected on a CHI 760E instrument at room temperature. The working electrode was initially aged by cyclic voltammetry for 200 cycles at 100 mV/s, between −0.6 and 0.4 V vs. Hg/Hg₂SO₄, to establish a stable cycling behavior. Then, cyclic voltammetry was performed at a series of scan rates from 1 to 500 mV/s between −0.6 and 0.4 V vs. Hg/Hg₂SO₄.

The average capacitances were calculated from their CV data according to the following equation:

$$C = \frac{\int {i}_{m} EdE}{2 v Δ E}$$

where C (F/g) is the specific capacitance, iₘ (A/g) and E (V) are specific current and potential in voltammogram, v (V/s) is the scan rate, and ΔE (V) is the potential window. The mass considered for calculating the specific currents (A/g) and capacitance (F/g) values refer to the active material's mass.

GCD tests were performed at a series of specific currents from 0.2 to 100 A/g between −0.6 and 0.4 V vs. Hg/Hg₂SO₄. SPECS measurements were performed using a potential step of 25 mV between −0.6 and 0.4 V with an equilibration time of 300 s. Synthesis of Phloroglucinol-Based HCP

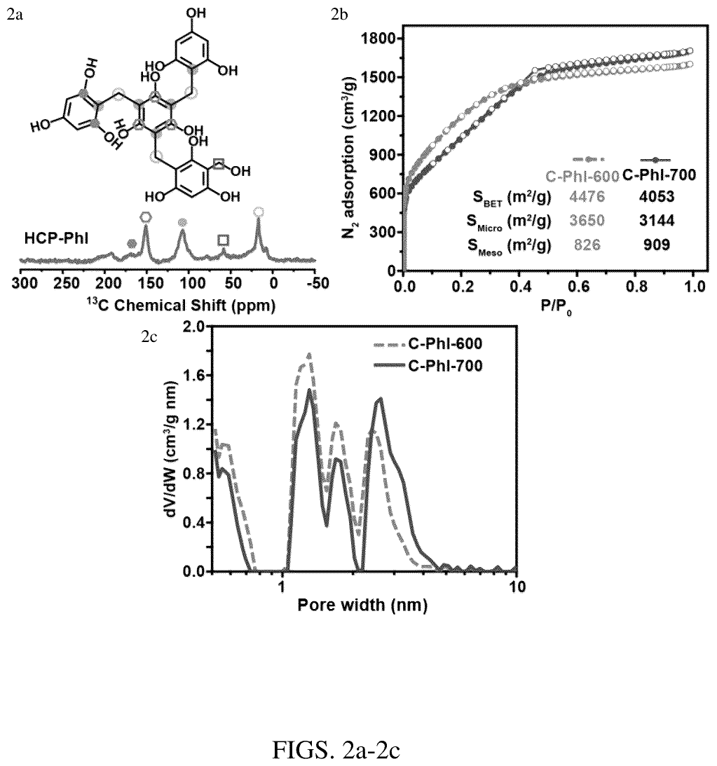

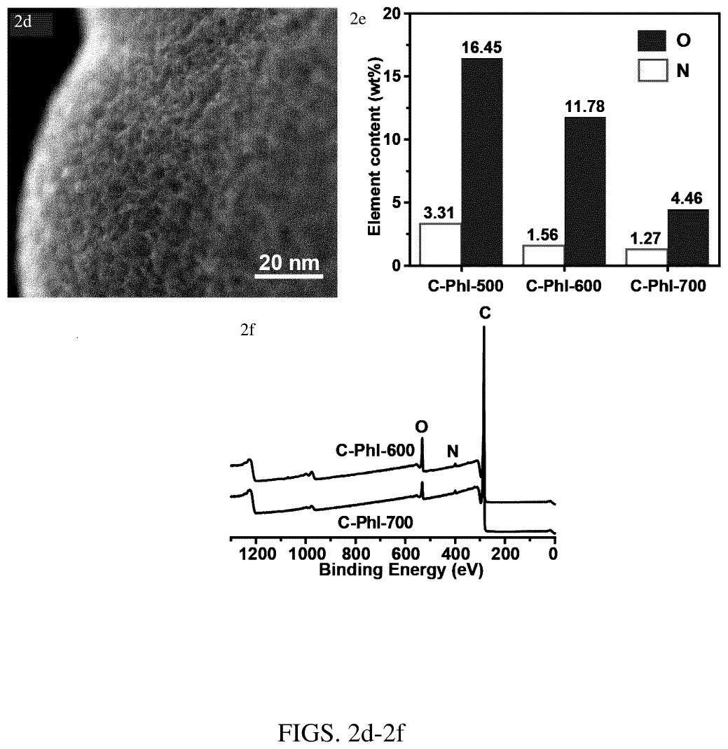

Phloroglucinol units were hypercrosslinked based on the Friedel-Crafts reaction, and the resulting polymer is referred to as HCP-Phl. During the crosslinking process, FDA was used as an external linker to crosslink the aromatic rings in phloroglucinol with methylene groups. The formation of methylene groups was validated by the strong resonance peak at 17.5 ppm in the ¹³C cross-polarization magic-angle spinning (CP/MAS) NMR spectrum (FIG. 2a). A weak signal at 58 ppm is attributed to a methoxy group attached to aromatic carbons. The strong resonance peak at 107 ppm is assigned to aromatic carbons bonded to methylene linkers, and the peaks at 150-160 ppm are assigned to aromatic carbons connected to OH. The NMR results validate the successful crosslinking of phloroglucinol with methylene groups.

### Carbonization of Phloroglucinol-Based HCP

HCP-Phl as the carbon precursor was mixed with NaNH₂ and heated to 350° C. to pre-activate polymer in molten NaNH₂. The mixture was then further heated to 600° C. to obtain hyperporous carbon (i.e., C-Phl-600 or “C-Phl”). C-Phl-700 was synthesized as a reference sample by changing the activation temperature from 600 to 700° C.

The pore structures and surface areas of hyperporous carbons were investigated by N₂ adsorption-desorption isotherms at 77 K. As shown in FIG. 2b, C-Phl-600 (i.e., C-Phl) and C-Phl-700 having similar N₂ adsorptions, are both hyperporous carbons with ultrahigh BET surface areas (S_{BET}s) of 4476 and 4053 m²/g, respectively. Although the S_{BET} of C-Phl-700 is lower than that of C-Phl-600, C-Phl-700 has a slightly larger surface area from mesopores, which corresponds to more abundant and larger mesopores in the non-local density functional theory (NLDFT) pore distribution (FIG. 2c). A large number of mesopores with width from 2 to 5 nm in C-Phl-600 can be directly observed in the scanning transmission electron microscopy (STEM) image shown in FIG. 2d, which is consistent with the NLDFT pore distribution. Moreover, as shown in FIG. 2e, the low-temperature activation is conducive to retaining a high oxygen content of 11.78 wt % in C-Phl-600. The increase of activation temperature from 600 to 700° C. results in a significantly decreased O content from 11.78 to 4.46 wt %.

As shown in FIG. 2f, the XPS spectra of C-Phl-600 and C-Phl-700 clearly reveal the signals from C, N, and O Is spectrum, which indicates the O/N co-doped carbon nature of these products. The C Is spectra show the C sp², C sp³, C sp³-OH, and C sp²=O peaks at 284.5, 285.2, 285.8 and 286.3 eV, respectively, where the sp³ C is 20% in total carbon. The absence of peaks in the XRD pattern (not shown) and the high I_{D}/I_{G} values above 3 in the Raman spectra (not shown) confirm the amorphous nature of C-Phl-600 and C-Phl-700. Compared to the target structure predicted by ANN machine learning (S_{micro}=3900 m²/g, Sₘₑₛₒ=1000 m²/g), C-Phl-600 has a similar S_{micro} of 3650 m²/g and Sₘₑₛₒ of 826 m²/g. Moreover, the low-temperature NaNH₂ activation can achieve high oxygen contents above 10 wt % and a nitrogen doping around 1 wt % in hyperporous carbons. Thus, C-Phl-600 and C-Phl-700 are hyperporous carbons with abundant heteroatom doping, which provides a route to approach the predicted capacitance boundary of porous carbons.

### Electrochemical Performance of Hyperporous Carbons

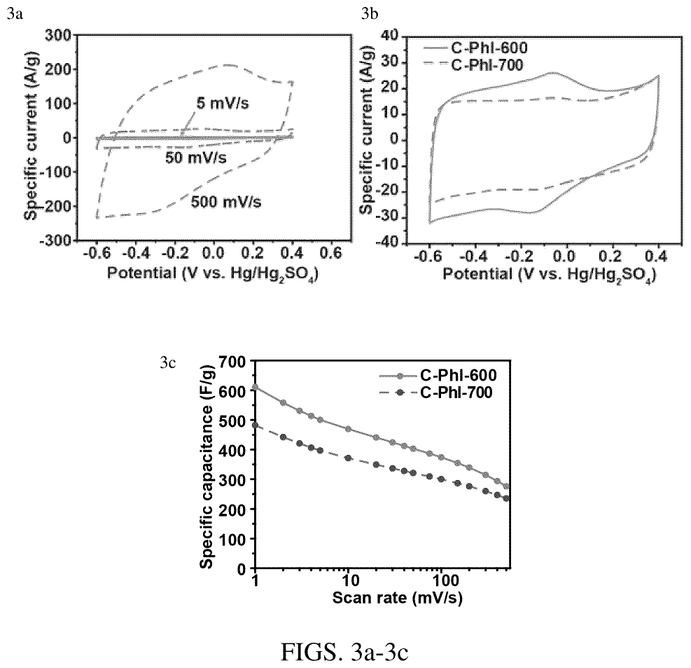

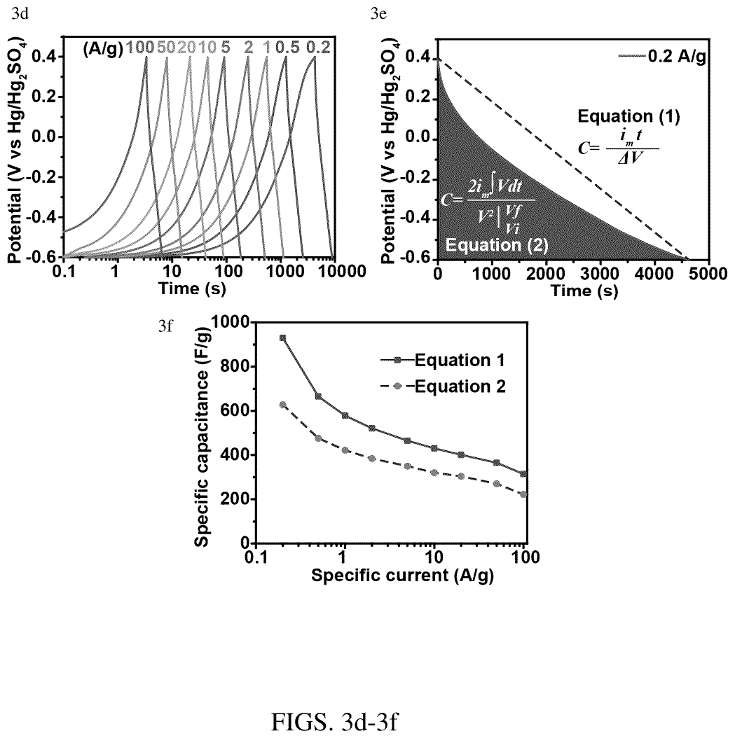

The electrochemical performance of hyperporous carbons was initially evaluated by cyclic voltammetry (CV) measurements at different scan rates from 1 to 500 mV/s in a conventional three-electrode system with 1 M H₂SO₄ solution as the electrolyte. The CV results are shown in FIG. 3a. As shown, these hyperporous carbons exhibited ultra-high capacitances up to 610 F/g at 1 mV/s, which surpasses the ANN model-predicted highest capacitance value (570 F/g) of porous carbons in 6 M KOH and approaches the capacitance boundary of porous carbon in 1 M H₂SO₄. The similar pore structures and different O contents of C-Phl-600 and C-Phl-700 make them good models for investigating the influences of pore structure and O doping on the electrochemical behaviors of hyperporous carbons.

As shown in FIG. 3b, C-Phl-600 and C-Phl-700 both exhibited rectangle-like CV curves, while the enclosed area of the CV curve was larger in C-Phl-600. Besides the stretched rectangle shape, the CV curves of hyperporous carbons reveal both singular peaks due to the redox processes of N/O-species and broad distributions of peaks due to delocalized electrons. The larger capacitance of C-Phl-600 is mainly from its enhanced redox peaks around-0.1 V (vs. Hg/Hg₂SO₄), benefiting from its higher O contents. As shown in FIG. 3c, the specific capacitance of C-Phl-600 is much higher than that of C-Phl-700 at 1 mV/s (610 vs. 482 F/g), while the gap narrows at higher scan rates (e.g., 277 vs. 236 F/g at 500 mV/s), which indicates a better rate performance of C-Phl-700. The rate performance of C-Phl-600 was further investigated by galvanostatic charge-discharge (GCD) tests under different specific currents from 0.2 to 100 A/g, with the results shown in FIG. 3d.

As shown in FIG. 3e, the average capacitance based on GCD curves was initially calculated to be 930 F/g at a specific current of 0.2 A/g by using the equation (1):

C=iₘt/ΔV (1)
where iₘ (A/g) is the specific discharge current, ΔV is the difference in discharge voltage, and t is the discharge time. However, the discharge curve of C-Phl-600 exhibited a negative slope, which means the faradic reaction charge/voltage ratio does not remain constant but varies with time. The non-linearities in GCD curves are characteristic behavior of porous electrode capacitors, which cannot be properly described by a classic RC model (B. E. Conway et al., J. Power Sources 105, 169-181, (2002)). The use of equation (1) will overestimate the capacitance from GCD curves. For this case, the integration of equation (2) was used to describe the average capacitance of non-symmetric discharge curves:

$$C = \frac{2 {i}_{m} \int Vdt}{{V}^{2} {\vert}_{Vi}^{Vf}} \qquad ( 2 )$$

where iₘ (A/g) is the specific discharge current, ∫Vdt is the integral area of the discharge curve, and Vᵢ and Vⱼ are the initial and final potential, respectively. As shown in FIG. 3f, the specific discharge capacitance was calculated as 628 F/g at 0.2 A/g using the integration equation (2), which was close to the value (610 F/g) calculated from CV curves at 1 mV/s. In addition, the specific capacitance of C-Phl-600 was as high as 223 F/g even at a high specific current of 100 A/g, suggesting excellent rate performance.

Moreover, the specific capacitance of C-Phl-600 remained 89% after 10000 GCD cycles at a specific current of 20 A/g and 92% after 25000 cycles at a higher specific current of 50 A/g, validating the excellent long-term cyclic stability. During the voltage hold test, the working electrode is constantly exposed to the maximum potential. A capacitance loss of 47% occurs after 500 h of the voltage hold test to validate that the constant voltage hold test is more time efficient than a GCD cycling test.

Electrochemical impedance spectroscopy (EIS) was used to investigate the conductivity of hyperporous carbon electrodes. The overall Nyquist impedance plots of the C-Phl-600 and C-Phl-700 almost coincide, suggesting their similar resistance behaviors. At low frequencies from 0.1 to 1 Hz, the plots of C-Phl-600 and C-Phl-700 dispersed in nearly vertical lines, which were close to that of an ideal capacitor. At middle frequencies from 10 to 100 Hz, the Nyquist points have a slope of 45° because of the distributed resistance of porous carbon electrodes (F. Lufrano et al., Int. J. Electrochem. Sci 5, 903-916, (2010)). At high frequencies above 100 Hz, the electric series resistance (ESR) is higher in C-Phl-600 than that in C-Phl-700, which includes the electrolyte resistance, electrode/electrolyte interface resistance, and the collector/electrode contact resistance. Since the electrolyte and current collector are the same for different tests, the higher ESR indicates a slightly lower conductivity of C-Phl-600 than that of C-Phl-700.

Besides the low loading test (0.7 mg/cm² of active material), a high mass loading of 4.2 mg/cm² was used to evaluate the high-loading performance of C-Phl-600. From the results, it was found that the specific capacitances of high-loading electrodes at a low scan rate below 10 mV/s are very close to those of low loading ones. The volumetric capacitance of high loading electrodes is 776 F/cm³, higher than that of low loading ones (712 F/cm³). The rate performance of high loading electrodes at higher scan rates above 20 mV/s is not as good as that of low loading ones, mainly due to its increased electrode thickness from 30 to 157 μm.

### Synthesis of Other Hyperporous Carbons

To demonstrate the general applicability of the method for the synthesis of hyperporous carbons, benzene, phenol, and resorcinol were hypercrosslinked using a similar process as the synthesis of HCP-Phl, and the resulting polymers are referred to as HCP-Ben, HCP-Phe, and HCP-Res, respectively. From spectral analysis, resonance peaks near 137 and 130 ppm in the 13C NMR of HCP-Ben were identified and believed to originate from substituted and unsubstituted aromatic carbons, respectively. Insertion of methylene linkers at m-positions in phenol should result in the formation of aromatic carbon resonating at 135-140 ppm, which is not found in the ¹³C CP/MAS NMR of HCP-Phe. The absence of that signal suggests that the aromatic rings are linked via ortho and/or meta-positions in HCP-Phe, corresponding to the resonance peak at 130 ppm. The sharp peak at 150 ppm corresponds to aromatic carbon bonding to the hydroxyl group, indicating that phenolic hydroxyl groups are intact after cross-linking. All of the 13C NMR spectra of HCPs reveal peaks corresponding to methylene groups (15˜35 ppm), and the peak position shifts to the higher field side with the increase of hydroxyl groups in the monomer. The peaks of methylene linkers in NMR confirm the successful synthesis of HCPs based on benzene, phenol, resorcinol, and phloroglucinol.

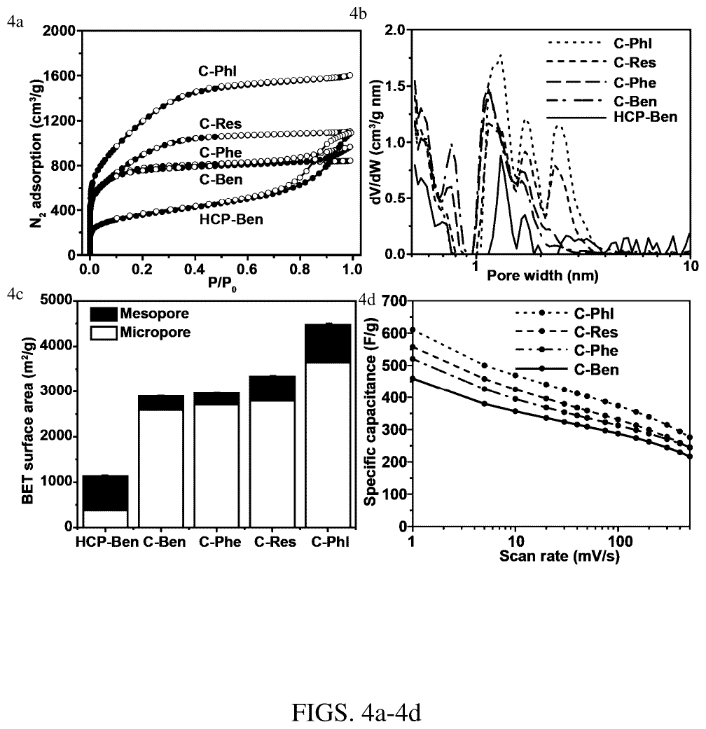

As shown in FIG. 4a, after NaNH₂ activation at 600° C., C-Ben exhibited a much higher N₂ uptake at a low-pressure region below 0.1 than HCP-Ben, indicating the formation of many micropores during the activation process. The detailed pore distribution was calculated based on the NLDFT model. As shown in FIG. 4b, the pore distribution of C-Ben exhibited significantly increased peaks below 2 nm compared to that of HCP-Ben, corresponding to the larger surface area contributed by micropores in C-Ben. Meanwhile, as shown in FIG. 4c, the BET surface area (S_{BET}) increased from 1132 m²/g of HCP-Ben to 2903 m²/g of C-Ben. The N₂ adsorption isotherm of C-Phe is almost coinciding with that of C-Ben, despite the slightly higher N₂ adsorption in C-Ben at the high-pressure region above 0.9. Considering the much lower BET surface area of HCP-Phe than that of HCP-Ben (16 vs. 1132 m²/g), the similar S_{BET} of C-Phe and C-Ben (2961 vs. 2903 m²/g) indicates that the introduction of phenolic hydroxyl groups contributes to a larger S_{BET} increment during NaNH₂ activation process. HCP-Res and HCP-Phl, having more phenolic hydroxyl groups, exhibited higher S_{BET}s of 3336 and 4476 m²/g in their carbon products C-Res and C-Phl, respectively (FIG. 4c). According to their pore distributions, the increase of phenolic hydroxyl groups in HCPs helps to achieve more micropores above 1.5 nm and mesopores below 3 nm but fewer micropores around 0.8 nm in hyperporous carbons (FIG. 4b). Besides the contribution to the high overall surface area, changing the monomer from benzene to phloroglucinol, the mesopore surface area (Sₘₑₛₒ) of the hyperporous carbon product remarkably increases from 310 to 826 m²/g (FIG. 4c).

With the high surface area and abundant O/N sites, all of the hyperporous carbons exhibited excellent electrochemical performance with specific capacitances higher than 450 F/g at 1 mV/s. The electrochemical performances are shown in FIG. 4d. The specific capacitances of hyperporous carbon are positively related to their specific surface area because the basic energy storage mechanism of carbon supercapacitors is electrical double-layer capacitance (EDLC). From C-Ben to C-Phl, the specific capacitance at 1 mV/s increases from 461 to 610 F/g, mainly from the increase of surface area. Based on the results above, it has herein been demonstrated that a series of hyperporous carbons with abundant O/N sites can be obtained by the general NaNH₂ activation of different HCPs, which are promising as outstanding electrode materials for supercapacitors.

### CONCLUSIONS

Guided by the ANN that predicted the capacitance boundary of N/O co-doped porous carbon supercapacitor, a series of hyperporous carbons featuring ultrahigh surface areas up to 4476 m²/g and high O contents above 10 wt % were designed and synthesized by the sodium amide activation of HCPs at a medium temperature. The medium temperature activation is conducive to achieving a high O doping content. The hydroxyl groups in monomers are conducive to a higher surface area in the resulting hyperporous carbon products. The specific capacitance of C-Phl-600 is as high as 610 F/g at a scan rate of 1 mV/s and 628 F/g at a specific current of 0.2 A/g in 1 M H₂SO₄ solution. C-Phl-600 and C-Phl-700 having comparable pore structure and heteroatom content, were used as model materials for the investigation of energy storage mechanisms. Based on the SPECS analysis, the high specific capacitance of C-Phl-600 is mainly contributed by mesopores and diffusion processes. According to QENS results, the functional groups in C-Phl-600 are more efficient in attracting the electrolyte components into the pores, which may be a decisive factor for the higher capacitance from mesopores and diffusion processes, while the faster dynamics of the electrolytes in C-Phl-700 correspond to the better rate performance of C-Phl-700. Carbon materials with higher mesopore surface area and higher O contents can be designed to break the current energy density and rate performance records of carbon supercapacitors. This work provides a novel data-driven discovery of optimized carbon materials for supercapacitor application and a promising SPECS-QENS method for the energy storage mechanism investigation.

While there have been shown and described what are at present considered the preferred embodiments of the invention, those skilled in the art may make various changes and modifications which remain within the scope of the invention defined by the appended claims.

What is claimed is:

1. A porous carbon material having a Brunauer-Emmett-Teller (BET) surface area of at least 2600 m²/g, an oxygen content of at least 1 wt %, a nitrogen content of at least 0.1 wt %, and wherein at least 80 vol % of pores in the porous carbon material have a pore size of no more than 10 nm.

2. The porous carbon material of claim 1, wherein the surface area is at least 3500 m²/g.

3. The porous carbon material of claim 1, wherein the surface area is at least 4000 m²/g.

4. The porous carbon material of claim 1, wherein the oxygen content is at least 5 wt %.

5. The porous carbon material of claim 1, wherein the oxygen content is at least 10 wt %.

6. The porous carbon material of claim 1, wherein the oxygen content is at least 15 wt %.

7. The porous carbon material of claim 1, wherein the nitrogen content is at least 0.5 wt %.

8. The porous carbon material of claim 1, wherein the nitrogen content is at least 1 wt %.

9. The porous carbon material of claim 1, wherein at least 90 vol % of pores in the porous carbon material have a pore size of no more than 10 nm.

10. The porous carbon material of claim 1, wherein at least 60 vol % of pores in the porous carbon material have a pore size within a range of 0.1-5 nm.

11. A method for producing a porous carbon material, the method comprising mixing a hypercrosslinked polymer with a metal amide or metal nitride to form a mixture, and heating the mixture to a temperature within a range of 350-1000° C. for a time period of at least 1 hour to result in conversion of the hypercrosslinked polymer to the porous carbon material, wherein the porous carbon material has a Brunauer-Emmett-Teller (BET) surface area of at least 2600 m²/g, an oxygen content of at least 1 wt %, a nitrogen content of at least 0.1 wt %, and wherein at least 80 vol % of pores in the porous carbon material have a pore size of no more than 10 nm.

12. The method of claim 11, wherein the heating step comprises two heating steps in which a first heating step subjects the mixture to a temperature in a range of 350-450° C. for at least one hour and the first heating step is followed by a second heating step which subjects the mixture to a temperature in a range of 500-1000° C. for at least one hour.

13. The method of claim 11, wherein the mixture is heated to a temperature within a range of 350-700° C. for a time period of at least 1 hour to result in conversion of the hypercrosslinked polymer to the porous carbon material.

14. The method of claim 11, wherein the mixture is heated to a temperature within a range of 350-600° C. for a time period of at least 1 hour to result in conversion of the hypercrosslinked polymer to the porous carbon material.

15. The method of claim 11, wherein the metal amide is selected from the group consisting of lithium amide, sodium amide, and potassium amide.

16. The method of claim 11, wherein the hypercrosslinked polymer contains aromatic rings.

17. The method of claim 11, wherein the hypercrosslinked polymer is derived from crosslinking of benzene, phenol, resorcinol, or phloroglucinol with an aldehyde, acetal, or ketal under Friedel-Crafts conditions.

18. The method of claim 11, wherein the surface area is at least 3500 m²/g.

19. The method of claim 11, wherein the surface area is at least 4000 m²/g.

20. The method of claim 11, wherein the oxygen content is at least 5 wt %.

21. The method of claim 11, wherein the oxygen content is at least 10 wt %.

22. The method of claim 11, wherein the oxygen content is at least 15 wt %.

23. The method of claim 11, wherein the nitrogen content is at least 0.5 wt %.

24. The method of claim 11, wherein the nitrogen content is at least 1 wt %.

25. The method of claim 11, wherein at least 90 vol % of pores in the porous carbon material have a pore size of no more than 10 nm.

26. The method of claim 11, wherein at least 60 vol % of pores in the porous carbon material have a pore size within a range of 0.1-5 nm.
